(19) United States
(12) Patent Application Publication
(10) Pub. No.: US 2015/0188249 A1
(43) Pub. Date: Jul. 2, 2015

(54) AC CABLE ASSEMBLY INTERCONNECTION TECHNOLOGIES FOR MICROINVERTER ARRAY

(71) Applicant: Fabio Pereira, Austin, TX (US)

(72) Inventor: Fabio Pereira, Austin, TX (US)

(21) Appl. No.: 14/585,647

(22) Filed: Dec. 30, 2014

Related U.S. Application Data
(60) Provisional application No. 61/922,552, filed on Dec. 31, 2013.

(51) Int. Cl. H01R 13/24; H02J 3/38; H01R 13/639

(52) U.S. Cl. CPC H01R 13/24; H01R 13/2457; H01R 13/2421; H01R 13/245; H01R 13/639; H02J 3/38

(57) ABSTRACT

Various AC cable assembly interconnection technologies for microinverter arrays are disclosed. In some embodiments, an AC cable assembly may include an AC cable connector having a plurality of spring contacts configured to contact an AC output connector of a microinverter. The spring contacts may be embodied as plunger spring contacts, stamped spring contacts, or other spring contact. The AC output connector of the microinverter includes a conductive land pattern, which is contacted by the plurality of spring contacts when the AC cable connector is mated with the AC output connector. The conductive land pattern may include multiple land patterns arranged in a circular pattern. The spring contacts of the AC cable connector may include redundant contacts configured to contact the same individual conductive land pattern. The disclosed technologies facilitate the connection of the AC cable connector and AC output connector in multiple orientations.

### CROSS-REFERENCE TO RELATED U.S. PATENT APPLICATION

The present application claims priority under 35 U.S.C. §119(e) to U.S. Provisional Patent Application Ser. No. 61/922,552, entitled “AC CABLE ASSEMBLY INTERCONNECTION TECHNOLOGIES FOR MICROINVERTER ARRAY” by Fabio Pereira, which was filed on Dec. 31, 2013, the entirety of which is hereby incorporated by reference.

### TECHNICAL BACKGROUND

The present disclosure relates, generally, to photovoltaic (PV) module systems and, more particularly, to cable assemblies and related interconnection technologies for interconnecting an array of microinverters of a PV module system.

### BACKGROUND

Photovoltaic (PV) modules typically include a large number of individual solar cells that each generate a small amount of DC power at very low voltage levels. As such, the individual solar cells are electrically connected together in serial strings of solar cells such that the PV module, as a whole, generates DC power at a low voltage level (e.g., about 25 volts). For example, as shown in FIG. 13, a typical photovoltaic module 1300 includes a housing 1302 and a plurality of solar cells 1304 defined on a front side 1306 of the housing 1302. To allow interconnection of the photovoltaic module 1300 with other modules 1300, typical photovoltaic modules 1300 include a junction box 1400 located on a back side 1408 of the housing 1302 as shown in FIG. 14. The junction box 1400 typically houses a simplistic, passive connection circuit 1402 that facilitates the interconnection of multiple photovoltaic modules 1300 in a parallel or serial configuration. A typical passive connection circuit 1402 may include a pair of bypass diodes, which provide an alternate current path through the photovoltaic module 1300 should one of the solar cell strings of the module 1300 become damaged, shaded, or otherwise inoperable. A pair of output wires 1404 extend from the junction box 1400 and allow the photovoltaic module 1300 to be coupled with other modules 1300 or with other electronic devices.

For example, as shown in FIG. 15, a DC-to-AC microinverter 1500 may be attached to the DC photovoltaic module 1300 to form a AC photovoltaic module 1502. The microinverters 1500 convert the DC power generated by the associated individual photovoltaic module 1300 to an AC power suitable for supplying energy to an AC grid and/or an AC load coupled to the AC grid. The microinverters 1500 may be coupled directly to the housing 1302 of the photovoltaic module 1300 via screws, adhesive, or other securing devices. Alternatively, the microinverters 1500 may be coupled directly to the junction box 1400. The output wires 1404 of the photovoltaic module 1300 are electrically coupled to input connections of the microinverter 1500.

Each of the microinverters 1500 typically includes an output cable 1504 extending therefrom, which may be used to electrically couple the microinverter 1500 together. To do so, a cable assembly 1510 may be used. A typical capable assembly 1510 includes a common truck cable 1412 from which multiple drop cables 1514 extend. Each drop cable 1514 includes an input connector 1516 configured to mate with an output connector 1518 of the output cable 1504 of the microinverter. The use of the drop cables 1514 of the cable assembly 1510 and the output cables 1504 of the microinverters 1500 provide some amount of flexibility in the configuration of the module array (e.g., the positioning of the individual ACPV modules 1502 and cable assembly 1510). However, the drop cables 1514 and the output cables 1504 increase the cost and complexity of the cable assembly 1510 and microinverter 1504, respectively.

### SUMMARY OF THE DISCLOSURE

According to one aspect, an alternating current (AC) cable assembly for interconnecting a plurality of microinverters includes a cable trunk line comprising a plurality of conductors and a plurality of in-line cable connectors. Each of the in-line cable connectors may be configured to couple to a corresponding AC output connector of one of the plurality of microinverters. Additionally, each of the in-line cable connectors may comprise a plurality of spring contacts configured to contact a conductive land pattern of the AC output connector when the corresponding in-line cable connector is coupled thereto.

In some embodiments, the plurality of spring contacts may include a pair of redundant spring contacts configured to contact the same conductive land pattern of the AC output connector. Additionally, in some embodiments, each spring contact may include a shaft, a contact head located at a distal end of the shaft, and spring positioned around the shaft, wherein the spring biases the contact head away from a housing of the in-line cable connector. In some embodiments, each spring contact may further include a protective sheath positioned around the spring. Additionally or alternatively, each spring contact comprises a stamped spring contact in some embodiments. In such embodiments, each stamped spring contact may include a base and at least two legs extending from the base. Each of the two legs may be biased away from a housing of the in-line cable connector and be configured to contact the same conductive land pattern of the AC output connector.

According to another aspect, an alternating current-to-direct current (AC-DC) microinverter may include a DC input to receive a DC input power from a DC source, an inverter circuit to convert the DC input power to an AC output power, and an AC output connector configured to couple to an AC cable connector of an AC cable assembly to supply the AC output power to the AC cable assembly. The AC output connector may include a circular conductive land pattern.

In some embodiments, the circular conductive land pattern may include a plurality of concentric circular conductive land patterns. For example, the circular conductive land pattern may include an outer concentric circular conductive land pattern, a first inner concentric circular conductive land pattern located within and spaced apart from the outer concentric circular conductive land pattern, a second inner concentric circular conductive land pattern located within and spaced apart from the first concentric circular conductive land pattern, and an inner concentric circular conductive land pattern located within and spaced apart from the second concentric circular conductive land pattern. Additionally, in some embodiments, each concentric circular conductive land pattern may provide an electrical connection to a different output connection of the AC-DC microinverter.

In some embodiments, the circular conductive land pattern may include (i) an outer ring land pattern having an upper half-ring land pattern and a lower half-ring land pattern spaced apart from the upper half-ring land pattern and (ii) an inner ring land pattern having an upper half-ring land pattern and a lower half-ring land pattern spaced apart from the upper half-ring land pattern. In some embodiments, each half-ring land pattern may provide an electrical connection to a different output connection of the AC-DC microinverter.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified illustration of at least one embodiment of a photovoltaic module array;

FIG. 2 is a simplified illustration of at least one embodiment of a AC input connector of a cable assembly of the photovoltaic module array of FIG. 1;

FIG. 3 is a simplified illustration of at least one embodiment of a spring contact of the AC input connector of FIG. 2;

FIG. 4 is a simplified illustration of at least one additional embodiment of the AC input connector of the cable assembly of the photovoltaic module array of FIG. 1;

FIG. 5 is a simplified illustration of at least one embodiment of spring contact of the AC input connector of FIG. 4;

FIGS. 6-9 are simplified illustrations of additional embodiments of spring contacts of the AC input connector of FIG. 4;

FIG. 10 is a simplified illustration of at least one embodiment of an output connector of the microinverters of the photovoltaic module array of FIG. 1;

FIG. 11 is a simplified illustration of at least one additional embodiment of the output connector of the microinverters of the photovoltaic module array of FIG. 1;

FIG. 12 is a simplified illustration of the cable assembly of FIG. 1 coupled to multiple ACPV modules in various orientations;

FIGS. 13 and 14 are simplified illustrations of typical photovoltaic modules; and

FIG. 15 is a simplified illustration of the typical photovoltaic modules of FIGS. 13 and 14 coupled together in a module array using a typical cable assembly.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C): (A and B); (B and C); or (A, B, and C). Similarly, items listed in the form of “at least one of A, B, or C” can mean (A); (B); (C): (A and B); (B and C); or (A, B, and C).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

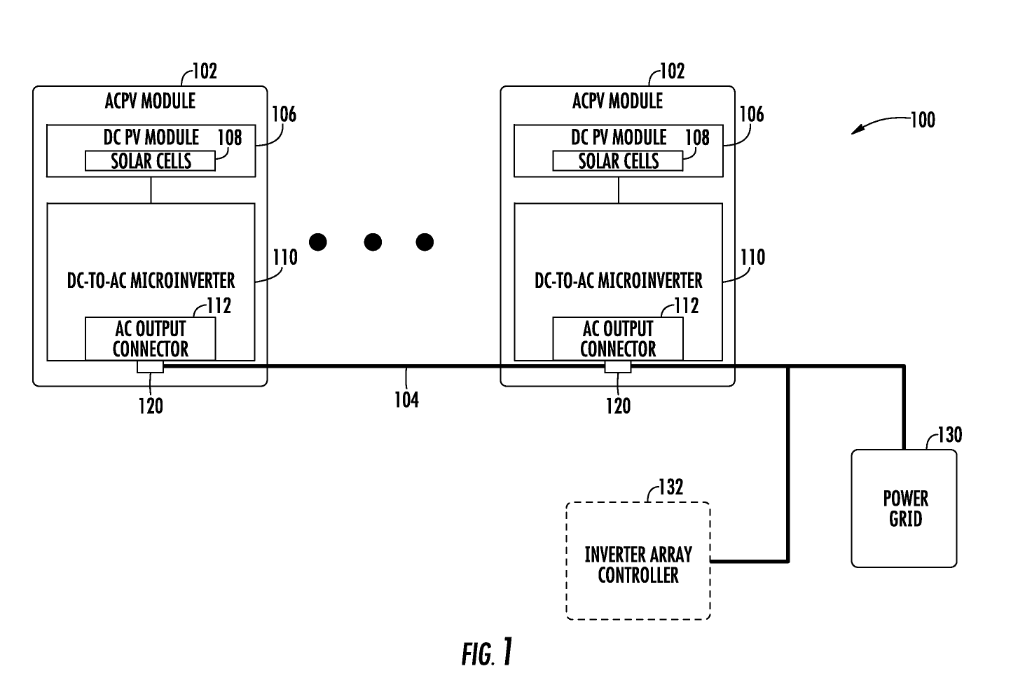

Referring now to FIG. 1, an illustrative photovoltaic module array 100 includes a plurality of alternating current-to-direct current photovoltaic (ACPV) modules 102 electrically coupled together via an alternating current (AC) cable assembly 104. Each of the of the ACPV modules 102 includes a DC PV module 106, which includes a plurality of solar cells 108 to convert solar energy to DC power. Each ACPV module 102 also includes a DC-to-AC microinverter 110 electrically coupled to the DC PV module 106 (e.g., via a junction box (not shown) of the DC PV module 106).

Each microinverter 110 is configured to convert a DC power output, generated by the associated DC PV module 106, to an AC power output. To do so, each microinverter 110 includes an DC-AC inverter circuit (not shown), which may be of any suitable design. Illustrative DC-AC inverter circuits that may be employed in the microinverters 110 include, but are not limited to, those described in U.S. Pat. No. 8,174,856, entitled “Configurable Power Supply Assembly;” U.S. Pat. No. 8,193,788, entitled “Method and Device for Controlling a Configurable Power Supply to Provide AC and/or DC Power Output;” U.S. Pat. No. 8,599,587, entitled “Modular Photovoltaic Power Supply Assembly;” U.S. Pat. No. 8,611,107, entitled “Method and System for Controlling a Multi-stage Power Inverter;” and/or U.S. patent application Ser. No. 13/095,190, entitled “Multi-stage Power Inverter.” To facilitate interconnection of the microinverters 110, each microinverter 110 includes an AC output connector 112 at which the AC power output generated by the associated DC-AC inverter circuit is provided. As discussed in more detail below, the AC output connector 112 may be embodied as a contact land pattern of various geometries depending on the particular implementation.

The AC cable assembly 104 interconnects each of the microinverters 110 of the ACPV modules 102. To do so, the AC cable assembly 104 includes a plurality of AC cable connectors 120, each of which is configured to mate with a corresponding AC output connector 112 of a microinverter 110. As shown in FIG. 1, each of the illustrative AC output connectors 112 are embodied as “in-line” connectors. That is, the cable assembly 104 does not include a “drop down” cable connecting each AC cable connector 120 to the main truck line of the AC cable assembly 104. Rather, the AC cable connectors 120 may form an integral portion of the main truck line of the AC cable assembly (e.g., each AC cable connector 120 may be overmolded with the main truck line). The particular configuration of the AC cable connectors 120 may depend on the configuration of the corresponding AC output connector 112 as discussed in more detail below. In some embodiments, the AC cable assembly 104 is configured to provide a combined or total output power of the ACPV modules 102 to a power grid 130. Additionally, in some embodiments, photovoltaic module array 100 may include an inverter array controller 132 configured to control operation of the microinverters 110.

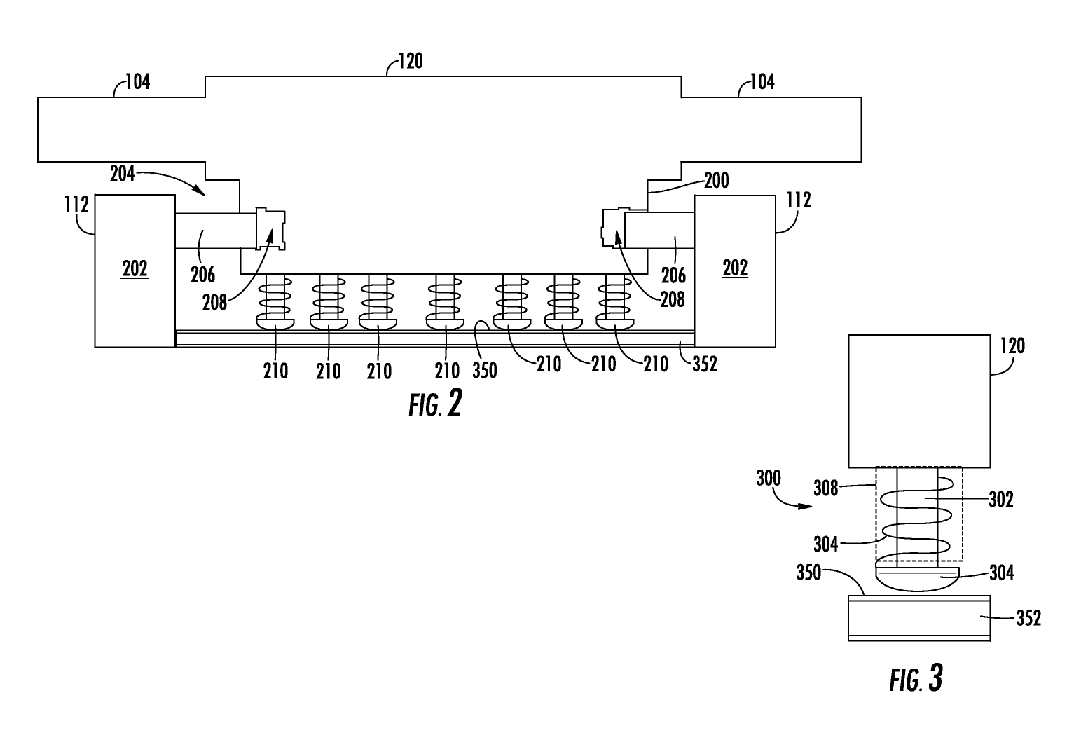

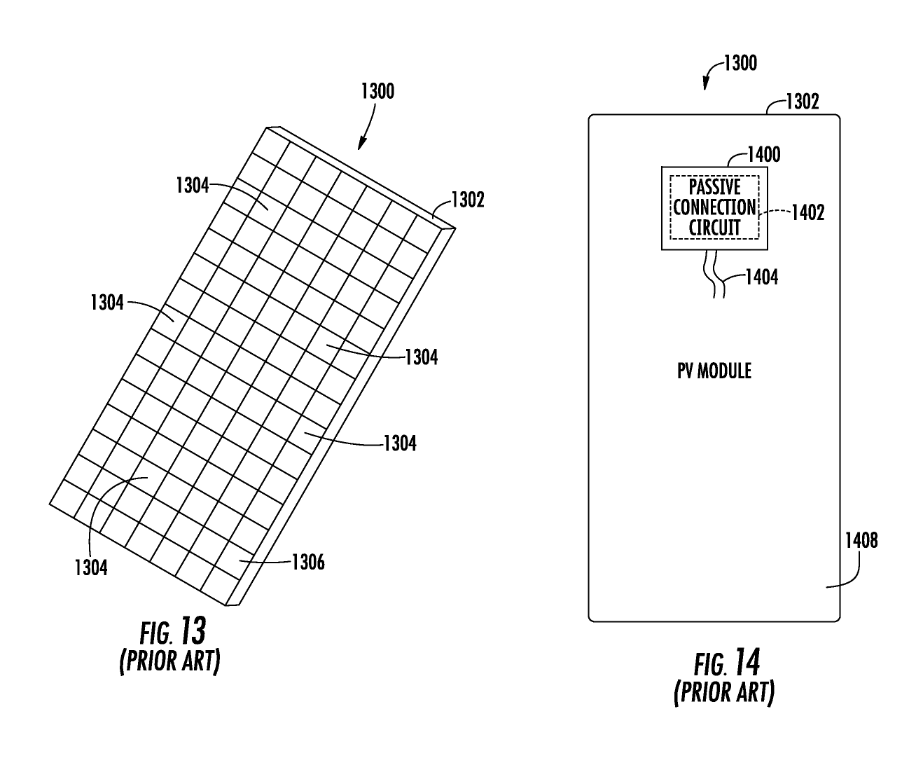

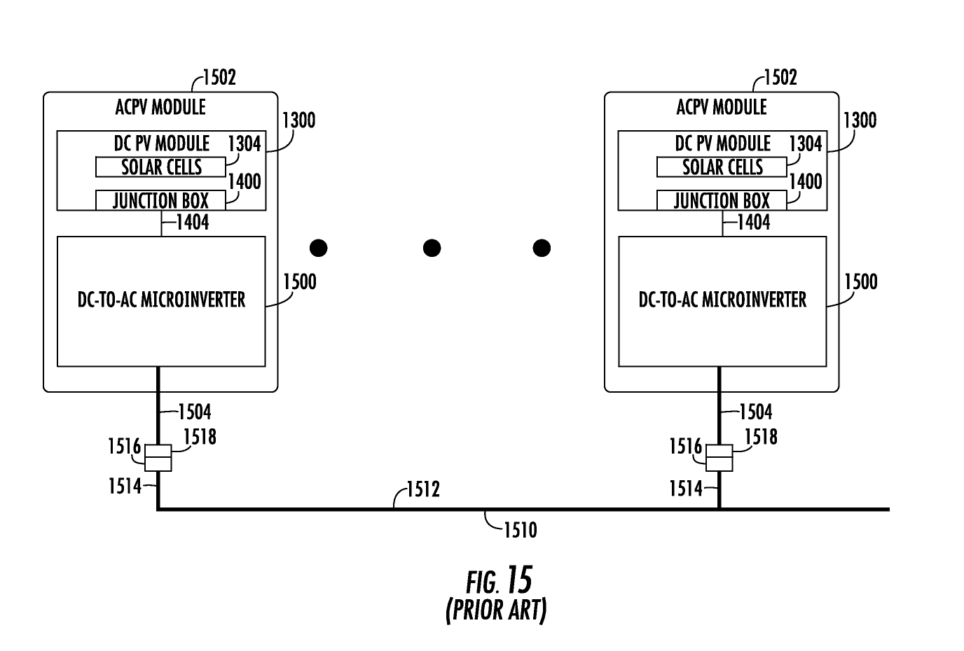

Referring now to FIG. 2, an illustrative embodiment of an AC cable connector 120 is shown. The illustrative AC cable connector 120 is overmolded with the main trunk cable of the AC cable assembly 104. Each of the AC cable connectors 120 may be spaced apart from each other a suitable distance to facilitate connection to ACPV modules 102 in various physical arrangements (e.g., in portrait and/or landscape mounting configuration as discussed below in regard to FIG. 12). The AC cable connectors 120 may be spaced equal distances from each other or varying distances from each other depending on the particular implementation. Each AC cable connector 120 includes a housing 200 configured to mate with a corresponding housing of a corresponding AC output connector 112. To secure the AC cable connector 120 to the AC output connector 112, the connectors 112, 120 may be keyed to each other (e.g., via a latch mechanism). For example, in the illustrative embodiment of FIG. 2, the AC output connector 112 includes a housing 202 having an opening 204 configured to receive a portion of the AC cable connector 120. The housing 202 includes associated latch mechanisms 206 extending into the opening 204 to facilitate attachment of the AC cable connector 120. The latch mechanisms 206 may be embodied as any type of latch mechanism capable of securing the AC cable connector 120 to the AC output connector 112 including, but not limited to, protrusions, spring-biased protrusions, clips, guides, rails, and/or the like. To secure the AC cable connector 120 to the AC output connector 112, an installer may insert the AC cable connector 120 into the opening 204 of the AC output connector 112 and latch the two connectors 112, 120 together by twisting the AC cable connector 120 in place (e.g., by twisting the AC cable connector 120 by 90 degrees) such that the latch mechanisms 206 are received in corresponding latch recesses 208 of the housing 200 of the AC cable connector 120. Of course, other latch mechanisms to secure the connectors 112, 120 to each other may be used in other embodiments. Additionally, in some embodiments, the AC cable connector 120 and/or the AC output connector 112 may include 0-rings and/or other sealing members to seal the connectors 112, 120 once attached and provide an amount of environmental protection.

As shown in FIG. 2, each AC cable connector 120 includes a plurality of spring contacts 210, which provide electrical connection between the electrical outputs of the associated microinverter 110 and the AC cable assembly 104. Illustratively, each of the spring contacts 210 is aligned with each other to form a row of spring contacts 210. Of course, the particular number of spring contacts 210 included in each AC cable connector 120 and their relative orientation may depend on the particular implementation, configuration of the microinverter 110, and/or other criteria. Regardless, in the illustrative embodiment, each AC cable connector 120 includes two or more individual spring contacts 210 for each electrical connection or power line. For example, the illustrative AC output connector 112 of the microinverters 110 includes two Line power outputs, a Neutral power output, and a Ground power output. As such, the illustrative AC cable connectors 120 include eight spring contacts 210, two for each power output of the AC output connector 112 to provide an amount of redundancy. Of course, in other embodiments, the AC cable connectors 120 may include additional redundant spring contacts 210 for increased redundancy.

Each of the spring contacts 210 is electrically connected to an electrical conductor of the AC cable assembly 104. For example, in the illustrative embodiment, each spring contact 210 is electrically crimped or soldered to an electrical conductor of the AC cable assembly 104 such that the electrical conductors of the AC cable assembly 104 are continuous and unbroken at the connection site of each AC cable connector 120. Such crimping or soldering may be automated in the manufacturing process. Regardless, once the electrical connections have been established, the AC cable connector 120 may be overmolded with the main truck line of the AC cable assembly 104 to provide an amount of environmental protection as discussed above.

In the illustrative embodiments of FIGS. 2 and 3, each of the spring contacts 210 is embodied as a plunger spring contact 300 having a shaft 302, a spring 304 positioned around the shaft 302, and a contact head 306 located at a distal end of the shaft 302. In some embodiments, the plunger spring contact 300 may also include a sheath 308 positioned to surround the shaft 302 and spring 304 to provide an amount of environmental protection. The spring 304 biases the plunger spring contact 300 away from the housing 200 of the AC cable connector 120. However, during interconnection of the AC cable connector 120 to the AC output connector 112, the plunger spring contact 300 may be depressed into the housing 200 of the AC cable connector 120 by compression of the spring 304.

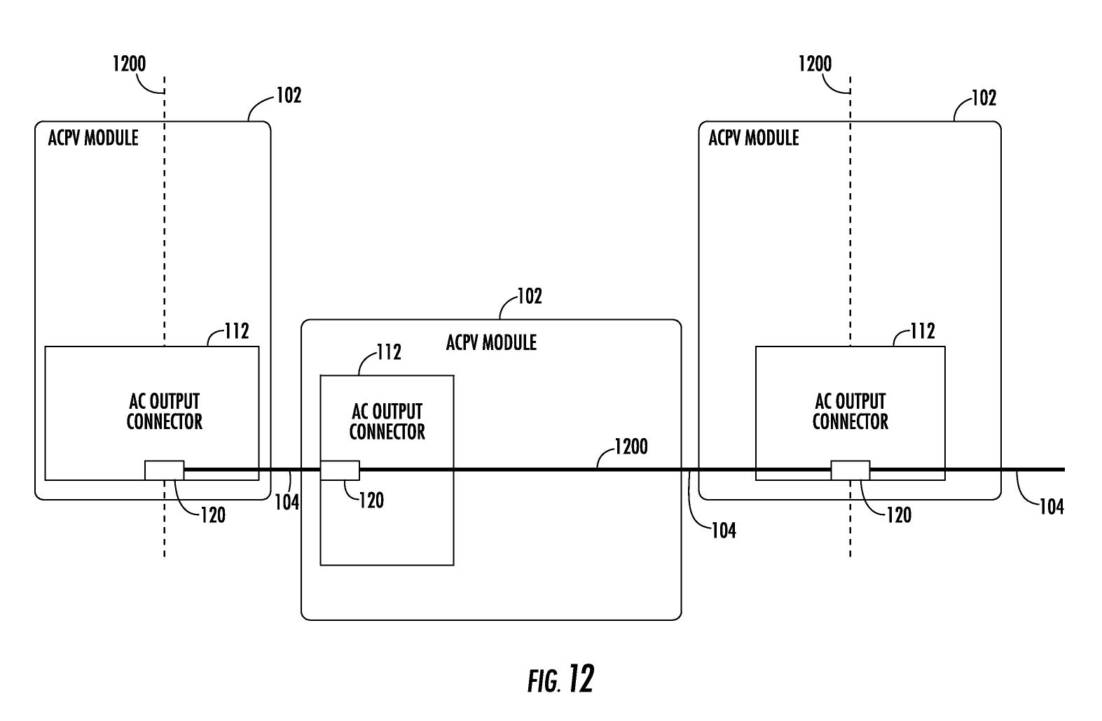

When the AC cable connector 120 is connected to the AC output connector 112, the contact head 306 makes electrical contact with a contact land pattern 350 of the AC output connector 112, which may be defined on a printed circuit board 352 of the microinverter 110 as discussed in more detail below in regard to FIGS. 10 and 11. It should be appreciated that the ability of the spring 304 to be depressed may facilitate attachment of the AC cable connector 120 to the AC output connector 112. Similarly, the biasing force of the spring 304 may allow the AC cable connector 120 to maintain electrical contact with the contact land pattern 350 of the AC output connector 112 during operation of the PV module array 100 (e.g., during rough environmental conditions).

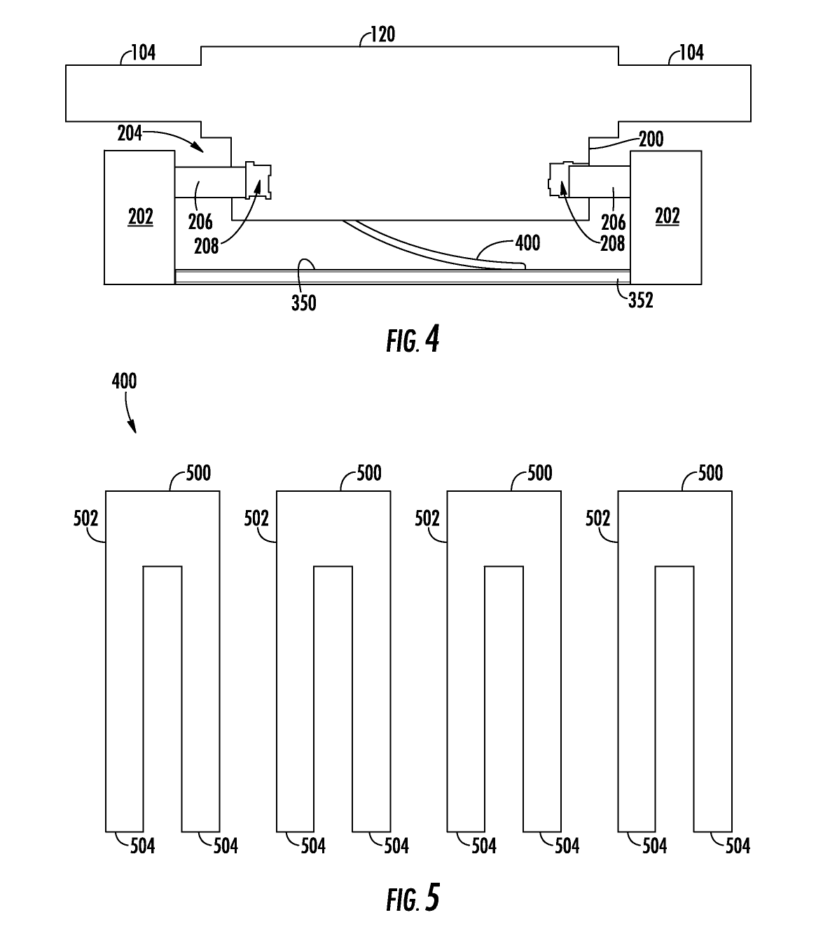

Referring now to FIGS. 4 and 5, in another illustrative embodiment, the spring contacts 210 of the AC cable connector 120 may be embodied as stamped spring contacts 400. The stamped spring contacts 400 may be formed from a stamped conductive material (e.g., a metallic material) and shaped to provide an amount of spring bias. For example, as shown in FIG. 4, the illustrative stamped spring contact 400 is biased away from the housing 200 of the AC cable connector 120 due to the “bow” shape of the stamped spring contact 400. Similar to the plunger spring contacts 300 of FIGS. 2 and 3, the stamped spring contact 400 makes electrical contact with the contact land pattern 350 of the AC output connector 112 when the AC cable connector 120 is connected to the AC output connector 112. Again, it should be appreciated that the biasing force of the stamped spring contact 400 (e.g., due to the “bow” shape) may allow the AC cable connector 120 to maintain electrical contact with the contact land pattern 350 of the AC output connector 112 during operation of the PV module array 100 (e.g., during rough environmental conditions).

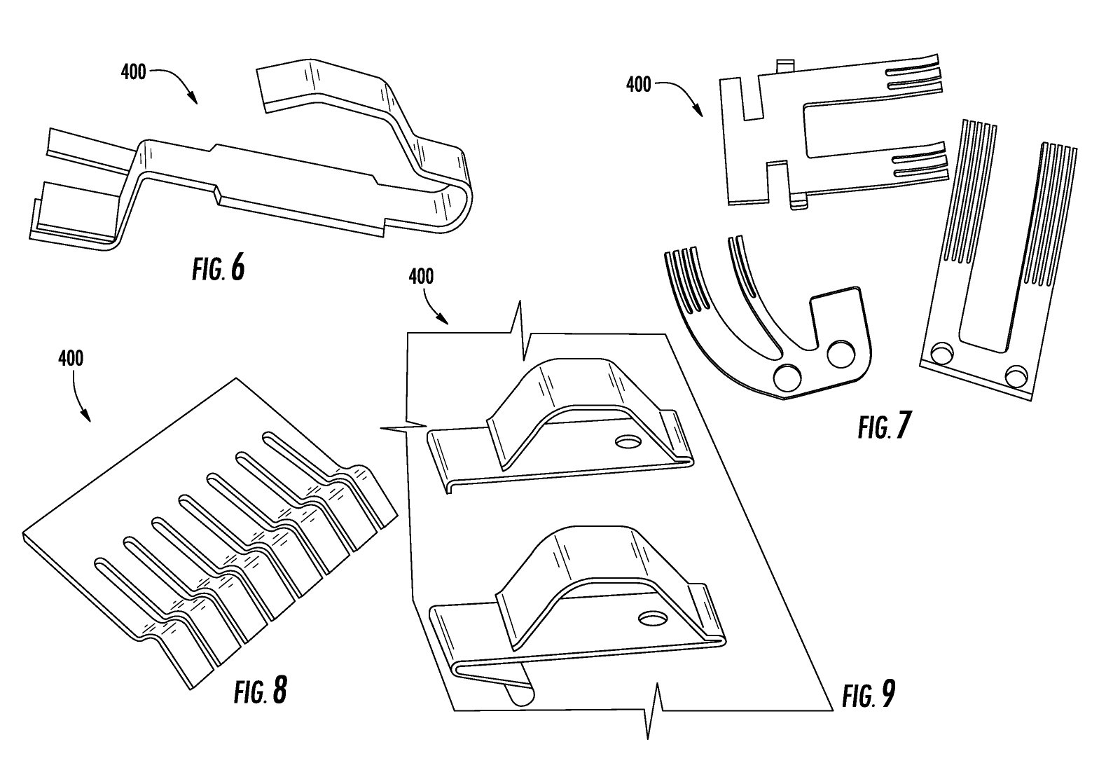

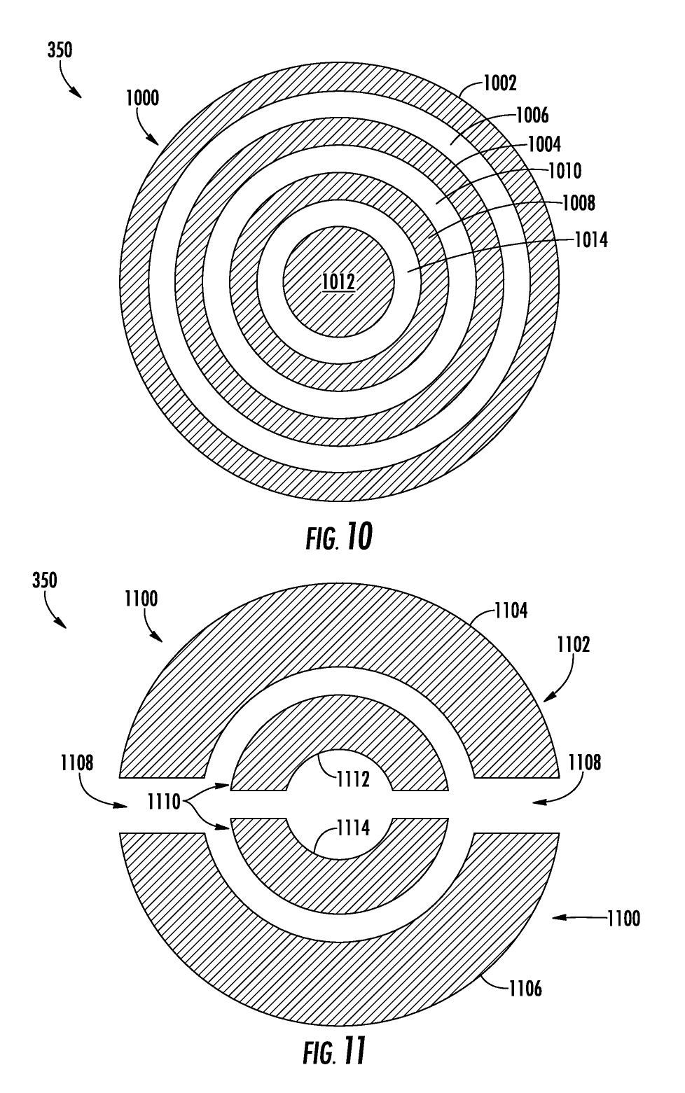

As with the plunger spring contacts 300 of FIGS. 2 and 3, the stamped spring contacts 400 may include multiple individual contacts to provide an amount of redundancy. For example, as shown in FIG. 5, the stamped spring contacts 400 may be embodied as a set of stamped spring contacts 500. Each stamped spring contact 500 includes a base 502 and a pair of contact legs 504 extending from the base 502. Each of the contact legs 504 has a bowed shape to provide an amount of biasing force as shown in FIG. 4. The dual contact legs 504 of each stamped spring contact 500 provide redundancy for the contact 500. In some embodiments, each contact leg 504 may include a contact pad located at a distal end to provide electrical contact with the contact land pattern 350 of the AC output connector 112. Various illustrative embodiments of stamped spring contacts 400 are shown in FIGS. 6-9. Of course, in other embodiments, the stamped spring contacts 400 may have different configurations.

Referring now to FIG. 10, in some embodiments, the contact land pattern 350 of the AC output connector 112 of each microinverter 110 may be embodied as a “bull's eye target” or concentric-circular land pattern 1000. In the illustrative embodiment, the concentric-circular land pattern 1000 includes a plurality of concentric, circular electrical land patterns, each of which may be formed from an electrically conductive material such as copper, gold, or other electrically conductive metal. The illustrative concentric-circular land pattern 1000 includes an outer concentric circle land pattern 1002, a first inner concentric circle land pattern 1004 separated from the outer concentric circle land pattern 1002 by a non-conductive pattern 1006, a second inner concentric circle land pattern 1008 separated from the first inner concentric circle land pattern 1004 by a non-conductive pattern 1010, and a central concentric circle land pattern 1012 separated from the second inner concentric circle land pattern 1008 by a non-conductive pattern 1014. In the illustrative embodiment of FIG. 10, each of the outer concentric circle land pattern 1002, the first inner concentric circle land pattern 1004, and the second inner concentric circle land pattern 1008 has an annular geometric shape. The width of the land patterns 1002, 1004, 1008 may be substantially equal as shown in FIG. 10. Additionally, the central concentric circle land pattern 1012 has a disk (e.g., filled circle) geometric shape.

The illustrative concentric-circular land pattern 1000 includes four different conductive land patterns, one for each of Line 1 power output, Line 2 power output, Neutral output, and Ground output. Of course, in other embodiments, the concentric-circular land pattern 1000 may include additional or fewer conductive land patterns (i.e., additional or fewer conductive concentric circle land patterns). The particular number of conductive land patterns and the shape and size of the individual land patterns may vary based on the particular implementation, the configuration of the microinverter 110, and/or other factors.

It should be appreciated that the circular shape of the concentric-circular land pattern 1000 facilities symmetrical connection with the AC cable connector 120 with up to 360 degrees of rotation. In some embodiments, the number of individual connection orientations between the AC cable connector 120 and the AC output connector 112 may be fixed based on the latch mechanisms 206 of the AC output connector 112 and the corresponding latch recesses 208 of the AC cable connector 120. For example, in some embodiments, the AC cable connector 120 may be attached to the AC output connector 112 in one of four different possible orientations, thus facilitating different orientations and configurations of the individual ACPV modules 102 as discussed below in regard to FIG. 12.

Referring now to FIG. 11, in other embodiments, the contact land pattern 350 of the AC output connector 112 of each microinverter 110 may be embodied as a split-circular land pattern 1100. The split-circular land pattern 1100 includes an outer ring conductive land pattern 1102 having an upper ring half 1104 spaced apart from a lower ring half 1106 by a non-conductive pattern 1108. Additionally, the split-circular land pattern 1100 includes an inner ring conductive land pattern 1110 having an upper ring half 1112 spaced apart from a lower ring half 1114 by the non-conductive pattern 1108. Again, the particular number of conductive land patterns and the shape and size of the individual land patterns of the split-circular land pattern 1100 may vary based on the particular implementation, the configuration of the microinverter 110, and/or other factors.

Similar to the concentric-circular land pattern 1000, the shape of the of the conductive ring land patterns 1104, 1106, 1112, 1114 facilities symmetrical connection with the AC cable connector 120 with up to about 180 degrees of rotation. Again, the number of individual connection orientations between the AC cable connector 120 and the AC output connector 112 may be fixed based on the latch mechanisms 206 of the AC output connector 112 and the corresponding latch recesses 208 of the AC cable connector 120. For example, in embodiments including the concentric-circular land pattern 1100, the AC cable connector 120 may be attached to the AC output connector 112 in one of two different possible orientations, thus facilitating different orientations and configurations of the individual ACPV modules 102. Additionally, due to the mirror symmetry of the split-circular land pattern 1100, the split-circular land pattern 1100 may have a smaller footprint thereby reducing the size and space requirement for the contact land pattern 350.

Referring now to FIG. 12, due to the symmetrical connection facilitated by the various embodiments of the AC cable connector 120 and the AC output connector 112 of the microinverters 110, each AC cable connector 120 may be coupled to a corresponding AC output connector 112 in one of a multiple number of orientations such that the ACPV modules 102 are interconnected in varying orientations. For example, as shown in FIG. 12, some of the ACPV modules 102 may be oriented in portrait while other ACPV modules 102 are oriented in landscape. In such a configuration, the longitudinal axes 1200 of the ACPV modules 102 may not be parallel with each other. For example, in the illustrative embodiment of FIG. 12, the longitudinal axis 1200 of the middle ACPV module (which is collinear with the AC cable assembly 104 in the illustration of FIG. 12) is substantially perpendicular to the longitudinal axes 1200 of the left-most and right-most ACPV modules 102. Regardless of the relative orientation of each ACPV module 102, the AC cable assembly 104 is capable of interconnecting each of the ACPV modules 102 because the multiple possible connection orientations provided by the symmetrical interconnection between the AC cable connector 120 and the AC output connector 112 as discussed above.

It should be appreciated that although the illustrative embodiments of the AC cable connector 120 and AC output connector 112 have been described above and shown in the attached figures as configured for use with conventional split-phase 240 V, 60 Hz wiring configurations, the AC cable connector 120 and AC output connector 112 may be used with other wiring configurations in other embodiments. For example, the AC cable connector 120 and AC output connector 112 may be used with 230 V, 50 Hz wiring configurations, which generally have three conductors. In such embodiments, the contact land pattern 350 may have only three different conductive land patterns (e.g., concentric-circular land pattern 1000 may include only the outer concentric circle land pattern 1002, the first inner concentric circle land pattern 1004, and the central concentric circle land pattern 1012. Similarly, in such embodiments, the split-circular land pattern 1100 may include only the upper ring half 1104 and the lower ring half 1106 of the outer ring conductive land pattern 1102 and an inner circular conductive land to provide three different conductive terminals. Likewise, in such embodiments, the AC cable connector 120 may include only six spring contacts 210 (i.e., three redundant pairs of contacts). Of course, in still other embodiments, the technologies disclosed herein may be utilized to configure the AC cable connector 120 and/or the AC output connector 112 for use with other wiring configurations having fewer (e.g., two wire) or greater (e.g., three phase wiring) conductive wires.

1. An alternating current (AC) cable assembly for interconnecting a plurality of microinverters, the AC cable assembly comprising:
a cable trunk line comprising a plurality of conductors;
a plurality of in-line cable connectors, each of the in-line cable connectors (i) configured to couple to a corresponding AC output connector of one of the plurality of microinverters and (ii) comprising a plurality of spring contacts configured to contact a conductive land pattern of the corresponding AC output connector when the in-line cable connector is coupled thereto.

2. The AC cable assembly of claim 1, wherein the plurality of spring contacts comprise a pair of redundant spring contacts configured to contact the same conductive land pattern of the AC output connector.

3. The AC cable assembly of claim 1, wherein each spring contact comprises a shaft, a contact head located at a distal end of the shaft, and spring positioned around the shaft, wherein the spring biases the contact head away from a housing of the in-line cable connector.

4. The AC cable assembly of claim 3, wherein each spring contact further includes a protective sheath positioned around the spring.

5. The AC cable assembly of claim 1, wherein each spring contact of the plurality of spring contacts is aligned with each other in a row.

6. The AC cable assembly of claim 1, wherein each spring contact comprises a stamped spring contact.

7. The AC cable assembly of claim 6, wherein each stamped spring contact comprises a base and at least two legs extending from the base, wherein each of the two legs are biased away from a housing of the in-line cable connector and are configured to contact the same conductive land pattern of the AC output connector.

8. The AC cable assembly of claim 1, wherein each in-line cable connector includes a housing having a plurality of latch recesses to receive corresponding latch mechanisms of the corresponding AC output connector when the when the in-line cable connector is coupled thereto.

9. An alternating current-to-direct current (AC-DC) microinverter comprising:
a DC input to receive a DC input power from a DC source;
an inverter circuit to convert the DC input power to an AC output power; and
an AC output connector configured to couple to an AC cable connector of an AC cable assembly to supply the AC output power to the AC cable assembly, wherein the AC output connector comprises a circular conductive land pattern.

10. The AC-DC microinverter of claim 9, wherein the circular conductive land pattern comprises a plurality of concentric circular conductive land patterns.

11. The AC-DC microinverter of claim 9, wherein the circular conductive land pattern comprises an outer concentric circular conductive land pattern, a first inner concentric circular conductive land pattern located within and spaced apart from the outer concentric circular conductive land pattern, a second inner concentric circular conductive land pattern located within and spaced apart from the first concentric circular conductive land pattern, and an inner concentric circular conductive land pattern located within and spaced apart from the second concentric circular conductive land pattern.

12. The AC-DC microinverter of claim 11, wherein each concentric circular conductive land pattern provides an electrical connection to a different output connection of the AC-DC microinverter.

13. The AC-DC microinverter of claim 11, wherein each of the outer concentric circular conductive land pattern, the first inner concentric circular conductive land pattern, and the second inner concentric circular land pattern has an annular geometric shape.

14. The AC-DC microinverter of claim 13, wherein the inner concentric circular conductive land pattern has a disk geometric shape

15. The AC-DC microinverter of claim 13, wherein each of the outer concentric circular conductive land pattern, the first inner concentric circular conductive land pattern, and the second inner concentric circular land pattern has a substantially equal width.

16. The AC-DC microinverter of claim 9, wherein the circular conductive land pattern comprises (i) an outer ring land pattern having an upper half-ring land pattern and a lower half-ring land pattern spaced apart from the upper half-ring land pattern and (ii) an inner ring land pattern having an upper half-ring land pattern and a lower half-ring land pattern spaced apart from the upper half-ring land pattern.

17. The AC-DC microinverter of claim 16, wherein each half-ring land pattern provides an electrical connection to a different output connection of the AC-DC microinverter.

18. A photovoltaic module array for generating an amount of AC power, the photovoltaic module array comprising:
a plurality of alternating current-to-direct current photovoltaic (ACPV) modules, wherein each ACPV module includes (i) a photovoltaic (PV) module to convert an amount of solar energy to DC power, (ii) a direct current-to-alternating current (AC-DC) microinverter to convert the DC power generated by the PV module to an AC power, and (ii) an AC output connector at which the AC power is supplied; and
an alternating current (AC) cable assembly including a cable trunk line and a plurality of in-line cable connectors, wherein each of the in-line cable connectors is securable to a corresponding AC output connector of an ACPV module in multiple orientations relative to the AC output connector.

19. The photovoltaic module array of claim 18, wherein each ACPV module includes a longitudinal axis and is secured to a common substrate such that the longitudinal axis of at least one ACPV module is not parallel with the longitudinal axis of another ACPV module of the plurality of ACPV modules.

20. The photovoltaic module array of claim 19, wherein the longitudinal axis of the at least one ACPV module is substantially perpendicular to the longitudinal axis of the another ACPV module of the plurality of ACPV modules.
